(19) United States
(12) Patent Application Publication
(10) Pub. No.: US 2009/0207410 A1
(43) Pub. Date: Aug. 20, 2009

(54) POSITION ADJUSTMENT MECHANISM FOR LASER OPTICS AND LASER ASSEMBLY HAVING THE SAME

(76) Inventors: Yung-Kuang Liu, Hsinchu (TW); Chih-Shun Huang, Hsinchu (TW); Hsien-Chang Chen, Hsinchu (TW); Tung-Chun Chiang, Hsinchu (TW)

Correspondence Address: Muncy, Geissler, Olds & Lowe, PLLC, P.O. BOX 1364, FAIRFAX, VA, 22038-1364, US

(21) Appl. No.: 12/357,097

(22) Filed: Jan. 21, 2009

(30) Foreign Application Priority Data
Feb. 19, 2008 (TW) 097105670

(51) Int. Cl. G01B 11/00

(52) U.S. Cl. 356/399

(57) ABSTRACT

A position adjustment mechanism for laser optics includes a fixed mount, a fastening member, and a position regulation device. The fixed mount is connected to a heat-dissipating mount and positioned near the optics mount. The fastening member penetrates the fixed mount and the optics mount to connect the fixed mount with the optics mount and maintains a gap between the fixed mount and the optics mount. The position regulation device is positioned in the vicinity of the fastening member and in the gap between the fixed mount and the optics mount. The position regulation device presses against the optics mount to adjust the position of the reflective element relative to the light-emitting device.

### CROSS REFERENCE TO RELATED APPLICATION

This application claims priority of application No. 097105670 filed in Taiwan R.O.C on Feb. 19, 2008 under 35 U.S.C. §119; the entire contents of which are hereby incorporated by reference.

### BACKGROUND OF THE INVENTION

1. Field of the Invention

The present invention relates to a position adjustment mechanism for laser optics, particularly to a position adjustment mechanism capable of adjusting the position of a reflective element relative to a light-emitting device in a laser assembly.

2. Description of the Related Art

Referring to FIG. 1, a conventional laser device 100 includes a heat-dissipating mount 102, at least one light-emitting device 104, an optics mount 106, a non-linear frequency-doubling chip 108, a reflective element 112 and a dust cover 114. The light-emitting device 104 and the optics mount 106 are arranged on a same surface of the heat-dissipating mount 102, and the reflective element 112 is installed on one side of the optics mount 106 and aligned with the light-emitting device 104 to form a light resonance cavity. The non-linear frequency-doubling chip 108 is installed on the same side of the optics mount 106 as the reflective element 112 and positioned between the light-emitting device 104 and the reflective element 112. The frequency-doubling chip 108 may double the frequency of emitting light of the light-emitting device 104 to enable the laser device to output visible light.

The reflective element 112 may be a volume bragg grating (VBG) or a notch filter. Since the gratings of the reflective element 112 must be positioned to be perpendicular to the emitting light of the light-emitting device 104 to form a light resonance cavity, the position of the reflective element 112 relative to the light-emitting device 104 in space must be very accurate. In the conventional design, the reflective element 112 is pasted to the optics mount 106 through an adhesive, and in order to keep precise positioning, a high-precision jig holds the reflective element 112 in place and does not detach the reflective element 112 until the adhesive fully solidifies. However, in the process of adhesive solidification, the high-precision jig is not allowed to detach the reflective element 112 or move to other place, so an auxiliary process used to accelerate adhesive solidification such as baking fails to apply to the fabrication of the conventional laser device 100. Hence, the assembly for the laser device 100 is time-consuming and thus unfavorable to mass production. Further, the high-precision jig is very expensive to considerably increase the fabrication cost of the laser device 100.

### BRIEF SUMMARY OF THE INVENTION

The invention relates to a position adjustment mechanism for laser optics having lower fabrication cost and reduced assembly time.

According to an embodiment of the invention, a position adjustment mechanism for laser optics is used in a laser device having a heat-dissipating mount, at least one light-emitting device, an optics mount, and a reflective element. The light-emitting device and the optics mount are provided on a first surface of the heat-dissipating mount and the reflective element is fixed on the optics mount. The position adjustment mechanism is used for adjusting the angle of incidence of the emitting light of the light-emitting device incident on the reflective element and includes a fixed mount, a fastening member, and a position regulation device. The fixed mount is connected to the first surface of the heat-dissipating mount and positioned near the optics mount. The fastening member penetrates the fixed mount and the optics mount to connect the fixed mount with the optics mount and maintains a gap between the fixed mount and the optics mount. The position regulation device is positioned in the vicinity of the fastening member and in the gap between the fixed mount and the optics mount. The position regulation device presses against the optics mount to adjust the position of the reflective element relative to the light-emitting device.

In one embodiment, the fastening member includes a first screw, and the position regulation device includes a wedge. The movement of an inclined plane of the wedge pressing against the optics mount allows for the position adjustment of the reflective element relative to the light-emitting device in space.

In one embodiment, the fastening member includes a main screw, and the position regulation device includes multiple adjustment screws around the main screw. The relative variation of insertion depths of the adjustment screws inserted into a gap between the fixed mount and the optics mount allows for the position adjustment of the reflective element relative to the light-emitting device in space.

In one embodiment, the fastening member includes a main screw, and the position regulation device includes an adjustment screw and a compression spring. The balance between insertion of the adjustment screw and resilient force of the compression spring allows for the position adjustment of the reflective element relative to the light-emitting device in space.

According to another embodiment of the invention, a laser assembly having a position adjustment mechanism includes a heat-dissipating mount, at least one light-emitting device, an optics mount, a reflective element, a frequency-doubling chip, a fixed mount, a fastening member, and a position regulation device. The light-emitting device is provided on a first surface of the heat-dissipating mount and adapted for emitting non-coherent light. The reflective element is installed on a side of the optics mount and provided in the propagation path of the non-coherent light, where the reflective element reflects at least part of the non-coherent light and the light-emitting device and the reflective element are spaced apart to form a light resonance cavity. The frequency-doubling chip is installed on the side of the optics mount and provided in the propagation path of the non-coherent light. The fixed mount is connected to the first surface of the heat-dissipating mount and positioned near the optics mount. The fastening member penetrates the fixed mount and the optics mount to connect the fixed mount with the optics mount, where a first, a second and a third reference axes perpendicular to one another are defined relative to the fastening member. The position regulation device is positioned in the vicinity of the fastening member and in at least one gap between the fixed mount and the optics mount, where the position regulation device presses against the optics mount to enable the optics mount to swing about at least one of the first, the second, and the third reference axes, so that the position of the reflective element relative to the light-emitting device is adjusted.

According to the above embodiments, a simple configuration is obtained to adjust the position of the reflective element relative to the light-emitting device in space. Hence, an expensive high-precision jig is no longer needed to considerably reduce the fabrication cost. Besides, the position adjustment mechanism is suitable to use in the fabrication that incorporates the process of accelerating adhesive solidification, so the time for assembling a laser assembly is reduced, which is highly beneficial for mass production.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

FIG. 1 shows a schematic diagram illustrating a conventional laser device.

FIG. 2 shows a schematic diagram illustrating a laser assembly with position adjustment mechanism according to an embodiment of the invention.

FIG. 3 shows another schematic diagram of the laser assembly for more clearly illustrating the position adjustment mechanism.

FIG. 4 shows a schematic diagram illustrating a fixed mount according to an embodiment of the invention.

FIGS. 5A and 5B show schematic diagrams illustrating the position adjustment according to an embodiment of the invention.

FIGS. 6A and 6B show schematic diagrams illustrating the position adjustment according to another embodiment of the invention.

FIGS. 7A and 7B show schematic diagrams illustrating the position adjustment according to another embodiment of the invention.

FIGS. 8A and 8B show schematic diagrams illustrating the position adjustment according to another embodiment of the invention.

FIG. 9 shows a schematic top view of the laser assembly shown in FIG. 2.

FIGS. 10A and 10B show schematic diagrams illustrating the position adjustment according to another embodiment of the invention.

FIG. 11 shows a schematic diagram illustrating a laser assembly with a position adjustment mechanism according to another embodiment of the invention.

FIG. 12 shows a schematic top view of the laser assembly shown in FIG. 11.

FIGS. 13A and 13B show schematic diagrams illustrating the position adjustment according to another embodiment of the invention.

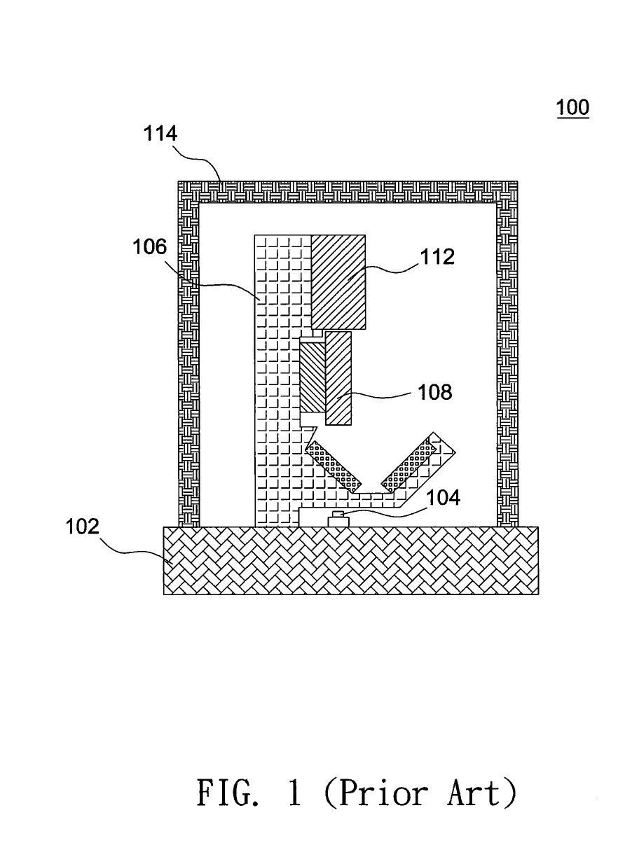

### DETAILED DESCRIPTION OF THE INVENTION

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” and variations thereof herein are used broadly and encompass direct and indirect connections, couplings, and mountings. Similarly, “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

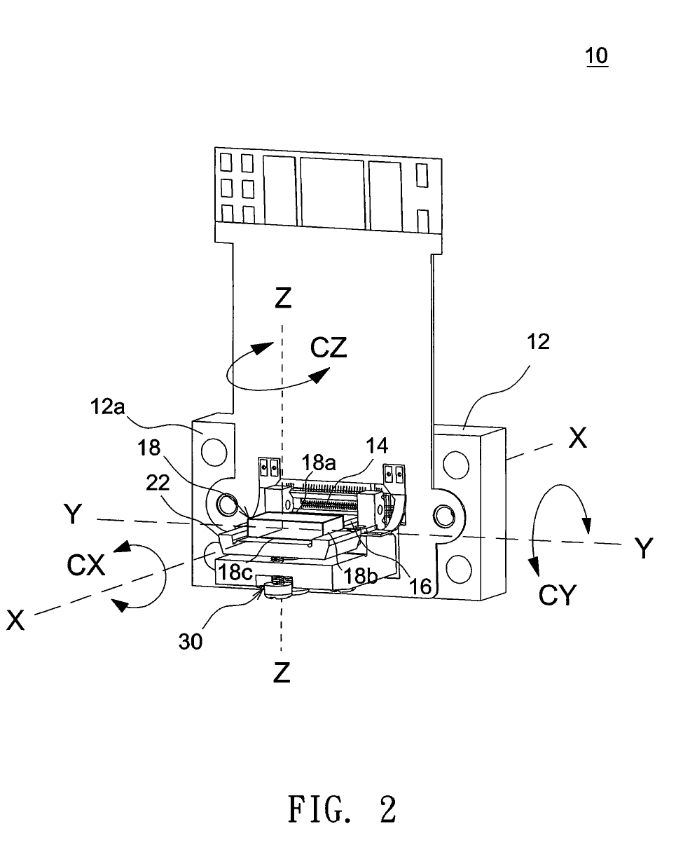

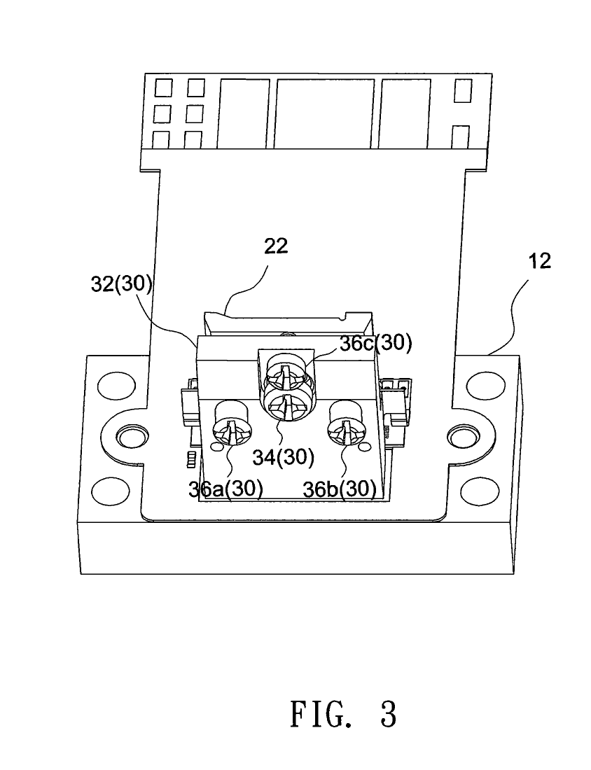

FIG. 2 shows a schematic diagram illustrating a laser assembly 10 with position adjustment mechanism according to an embodiment of the invention. FIG. 3 shows another schematic diagram of the laser assembly 10 for more clearly illustrating the position adjustment mechanism 30. Referring to FIG. 2, the laser assembly 10 includes a heat-dissipating mount 12, a light-emitting device 14, a frequency-doubling chip 16, a reflective element 18, an optics mount 22, and a position adjustment mechanism 30. The light-emitting device 14 and the optics mount 22 are provided on a same surface 12a of the heat-dissipating mount 12, and the frequency-doubling chip 16 and the reflective element 18 are fixed at a same side of the optics mount 22. The reflective element 18 is provided in the propagation path of non-coherent light emitted from the light-emitting device 14 and reflects at least part of the non-coherent light, where the light-emitting device 14 and the reflective element 18 are spaced apart to form a light resonance cavity. The frequency-doubling chip 16 is provided in the propagation path of non-coherent light and positioned between the light-emitting device 14 and the reflective element 18.

As shown in FIG. 2, the non-coherent light emitted from the light-emitting device 14 enters the reflective element 18 by its light-receiving surface 18a. The reflective element 18 has a bottom surface 18c that touches the optics mount 22 and a side surface 18b that is perpendicular to the light-receiving surface 18a and the bottom surface 18c. Hence, before the position of the reflective element 18 is adjusted, the normal directions of the light-receiving surface 18a, the side surface 18b, and the bottom surface 18c are respectively defined as X-axis, Y-axis and Z-axis, which serve as reference directions in a positioning process achieved by the position adjustment mechanism 30. The position adjustment mechanism 30 enables the reflective element 18 together with the optics mount 22 to swing about the X-axis (producing rotational movement along a rotation direction CX), the Y-axis (producing rotational movement along a rotation direction CY), or the Z-axis (producing rotational movement along a rotation direction CZ). Through the position adjustment, the angle of incidence of the emitting light of the light-emitting device 14 incident on the reflective element 18 may be accurately selected.

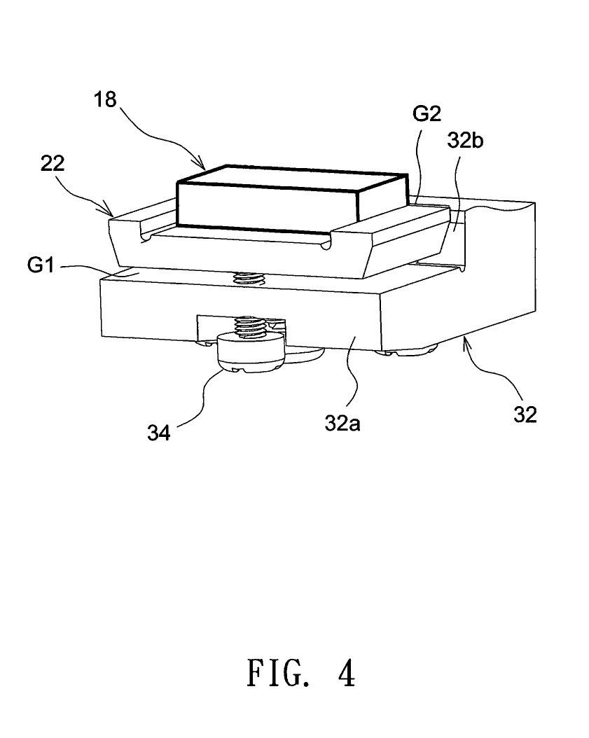

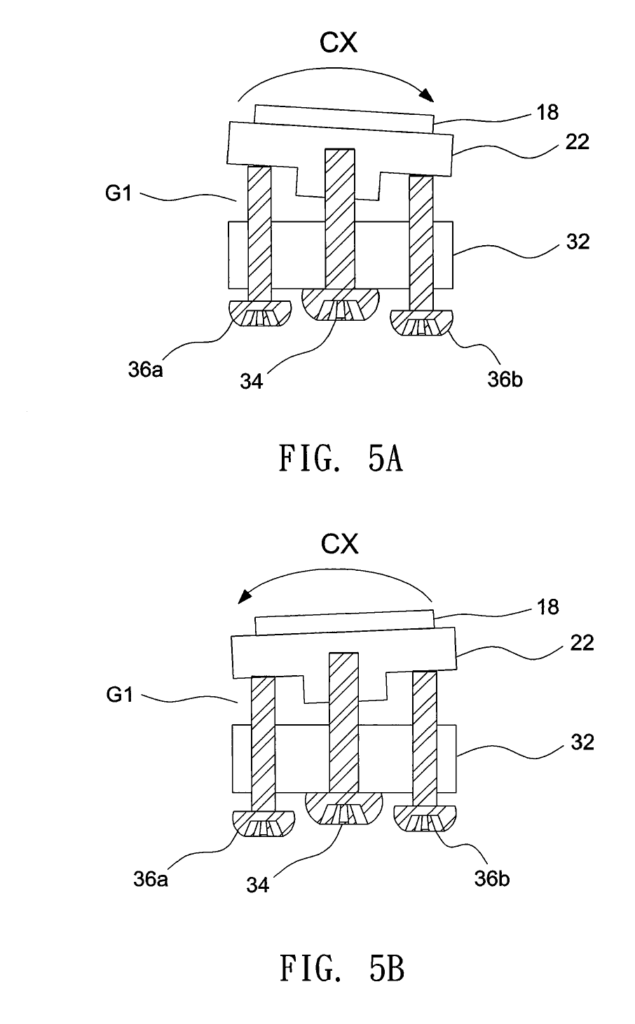

Referring to both FIG. 3 and FIG. 4, the position adjustment mechanism 30 includes a fixed mount 32, a fastening member 34, and a position regulation device that includes multiple regulation elements 36a, 36b and 36c. In this embodiment, the fastening member 34 is a main screw 34 and the regulation elements 36a, 36b and 36c are adjustment screws 36a, 36b and 36c. The fixed mount 32 is connected to a surface 12a of the heat-dissipating mount 12 and includes a base portion 32a and a side portion 32b that protrudes from the periphery of the base portion 32a. A first gap G1 is formed between the base portion 32a and the optics mount 22, and a second gap G2 is formed between the side portion 32b and the optics mount 22. The main screw 34 penetrates the fixed mount 32 and the optics mount 22 and connects the fixed mount 32 with the optics mount 22. When the main screw 34 is inserted into the tapped hole on the optics mount 22 along the Z-axis direction, the optics mount 22 is tightened towards the fixed mount 32. The adjustment screws 36a, 36b and 36c are positioned in the vicinity of the main screw 34, arrange in the shape of a triangle, and inserted into the first gap G1 between the base portion 32a of the fixed mount 32 and the optics mount 22 along the Z-axis direction. Hence, as shown in FIG. 5A, the adjustment screws 36a and 36b pass through the fixed mount 32 and press against the bottom of the optics mount 22. When the insertion depth of the adjustment screw 36a is larger than that of the adjustment screw 36b, the optics mount 22 together with the reflective element 18 are allowed to clockwise rotate about the main screw 34 along the rotation direction CX. In comparison, as shown in FIG. 5B, when the insertion depth of the adjustment screw 36b is larger than that of the adjustment screw 36a, the optics mount 22 together with the reflective element 18 are allowed to counterclockwise rotate about the main screw 34 along the rotation direction CX. Hence, by adjusting respective insertion depths of the adjustment screw 36a and the adjustment screw 36b that are both inserted into the first gap G1, the reflective element 18 is allowed to clockwise or counterclockwise rotate about the X-axis shown in FIG. 2 along the rotation direction CX, therefore achieving the position adjustment relative to one dimension in space for the reflective element 18.

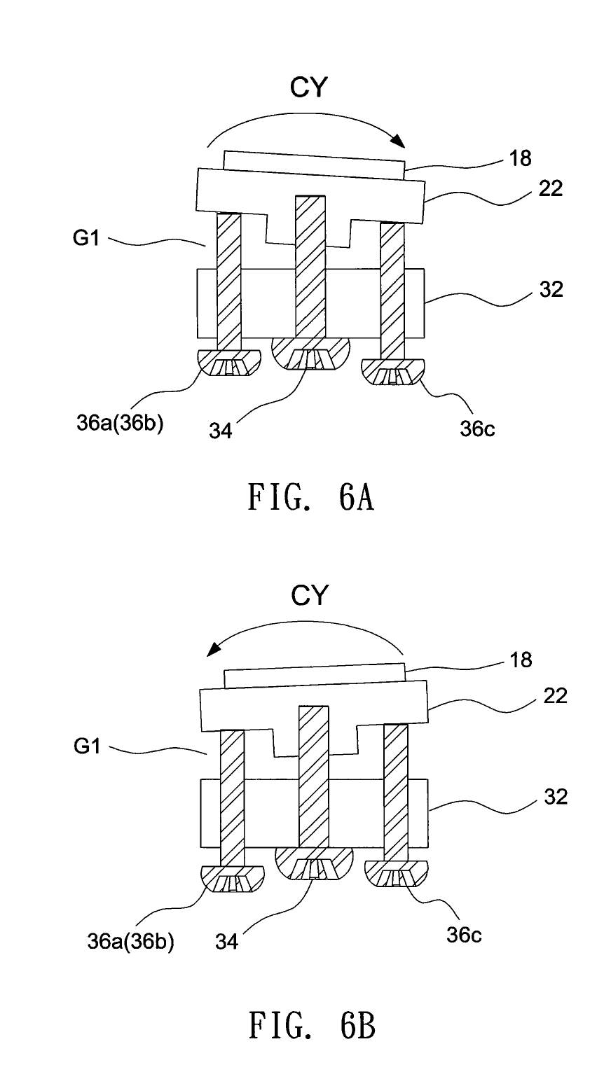

On the other hand, as shown in FIG. 6A, when the insertion depths of the adjustment screws 36a and 36b are larger than that of the adjustment screw 36c, the optics mount 22 together with the reflective element 18 are allowed to clockwise rotate about the main screw 34 along the rotation direction CY. In comparison, as shown in FIG. 6B, when the insertion depth of the adjustment screw 36c is larger than that of the adjustment screws 36a and 36b, the optics mount 22 together with the reflective element 18 are allowed to counterclockwise rotate about the main screw 34 along the rotation direction CY. Hence, by adjusting respective insertion depths of the adjustment screws 36a and 36b and the adjustment screw 36c that are both inserted into the first gap G1, the reflective element 18 is allowed to clockwise or counterclockwise rotate about the Y-axis along the rotation direction CY, therefore achieving the position adjustment relative to another dimension in space for the reflective element 18.

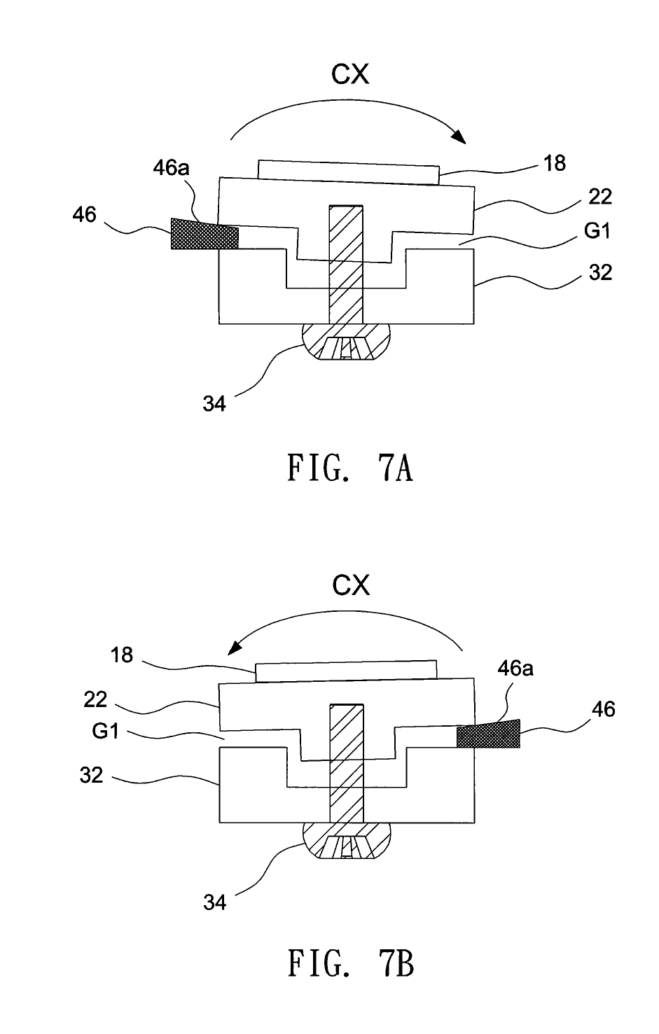

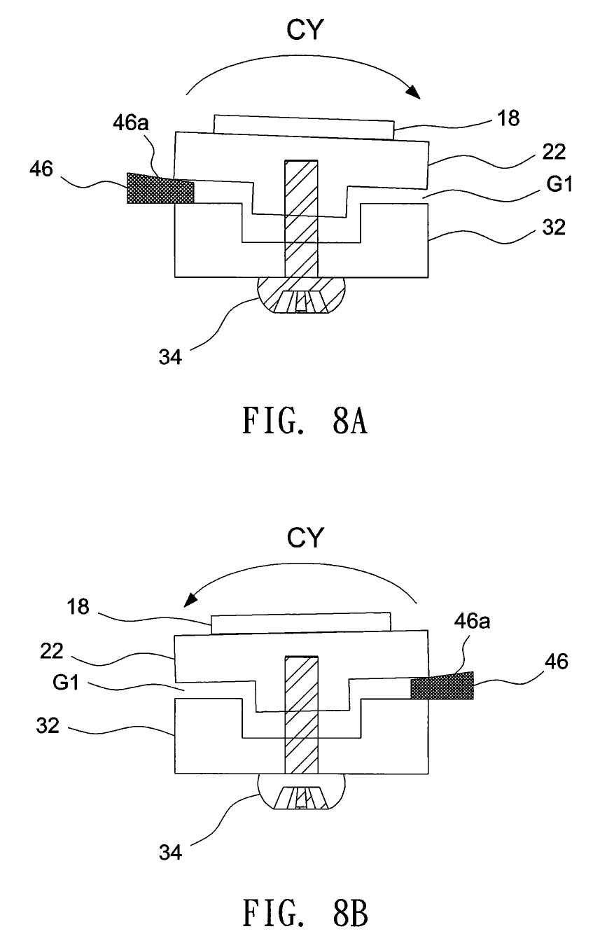

Referring to both FIG. 7A and FIG. 7B, in this embodiment, the position regulation device 46 is a wedge 46. When the main screw 34 penetrates the optics mount 22 and the fixed mount 32 and serves as a pivot axis for position adjustment, the wedge 46 is inserted into the first gap G1 between the optics mount 22 and the fixed mount 32 to achieve the position adjustment. For example, as shown in FIG. 7A, in case the wedge 46 is inserted into the first gap G1 by the left side of the main screw 34, the optics mount 22 together with the reflective element 18 are allowed to clockwise rotate along the rotation direction CX when an inclined plane 46a of the wedge 46 pressing against the optics mount 22 moves toward the main screw 34. In comparison, as shown in FIG. 7B, in case the wedge 46 is inserted into the first gap G1 by the right side of the main screw 34, the optics mount 22 together with the reflective element 18 are allowed to counterclockwise rotate along the rotation direction CX when an inclined plane 46a of the wedge 46 pressing against the optics mount 22 moves toward the main screw 34. Hence, the movement of the wedge 46 enables the position adjustment relative to one dimension in space for the reflective element 18. Similarly, as shown in FIGS. 8A and 8B, in case the wedge 46 is inserted into the first gap G1 by either of two opposite sides of the main screw 34 that are parallel to the Y-axis direction, the reflective element 18 is allowed to clockwise or counterclockwise rotate about the Y-axis along the rotation direction CY, therefore achieving the position adjustment relative to another dimension in space for the reflective element 18.

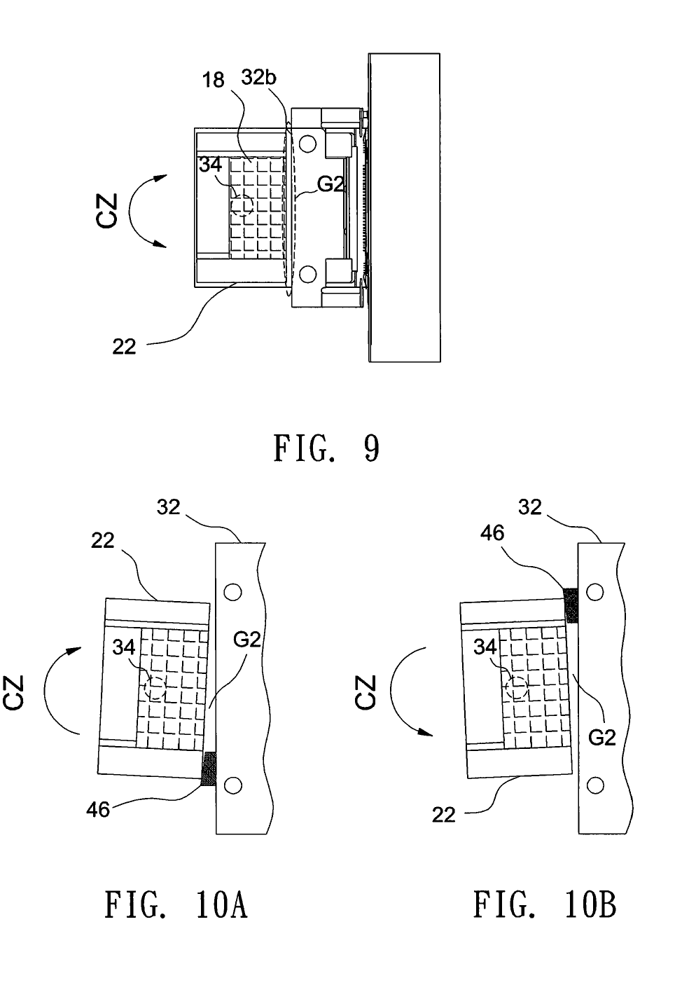

FIG. 9 shows a schematic top view of the laser assembly 10. Referring to both FIG. 9 and FIG. 4, it is clearly seen a second gap G2 is formed between the optics mount 22 and the side portion 32b of the fixed mount 32. Hence, when the wedge 46 is inserted into one side of the second gap G2 and moves toward the main screw 34 (shown in FIG. 10A), the optics mount 22 together with the reflective element 18 are allowed to clockwise rotate along the rotation direction CZ. In comparison, when the wedge 46 is inserted into another side of the second gap G2 and moves toward the main screw 34 (shown in FIG. 10B), the optics mount 22 together with the reflective element 18 are allowed to counterclockwise rotate along the rotation direction CZ. Hence in this embodiment, the reflective element 18 is allowed to clockwise or counterclockwise rotate about the Z-axis shown in FIG. 2 along the rotation direction CZ, therefore achieving the position adjustment relative to another dimension in space for the reflective element 18.

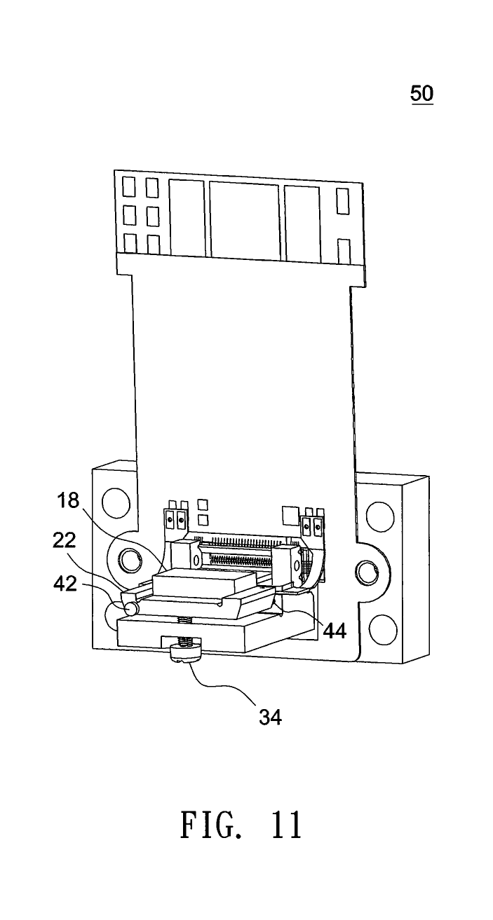

FIG. 11 shows a schematic diagram illustrating a laser assembly 50 with a position adjustment mechanism according to another embodiment of the invention. FIG. 12 shows a schematic top view of the laser assembly 50. In this embodiment, the fastening member 34 is a main screw 34 and the position regulation device includes an adjustment screw 42 and a compression spring 44. The main screw 34 penetrates the optics mount 22 and the fixed mount 32 and serves as a pivot axis for position adjustment. The adjustment screw 42 and the compression spring 44 are respectively positioned on two sides of the main screw 34. The adjustment screw 42 is inserted into the optics mount 22 and the second gap G2 along the X-axis direction and presses against the side portion 32b of the fixed mount 32, and the insertion direction of the adjustment screw 42 into the optics mount 22 is perpendicular to the insertion direction of the main screw 34 into the optics mount 22. The compression spring 44 is connected between the optics mount 22 and the fixed mount 32 (in the second gap G2).

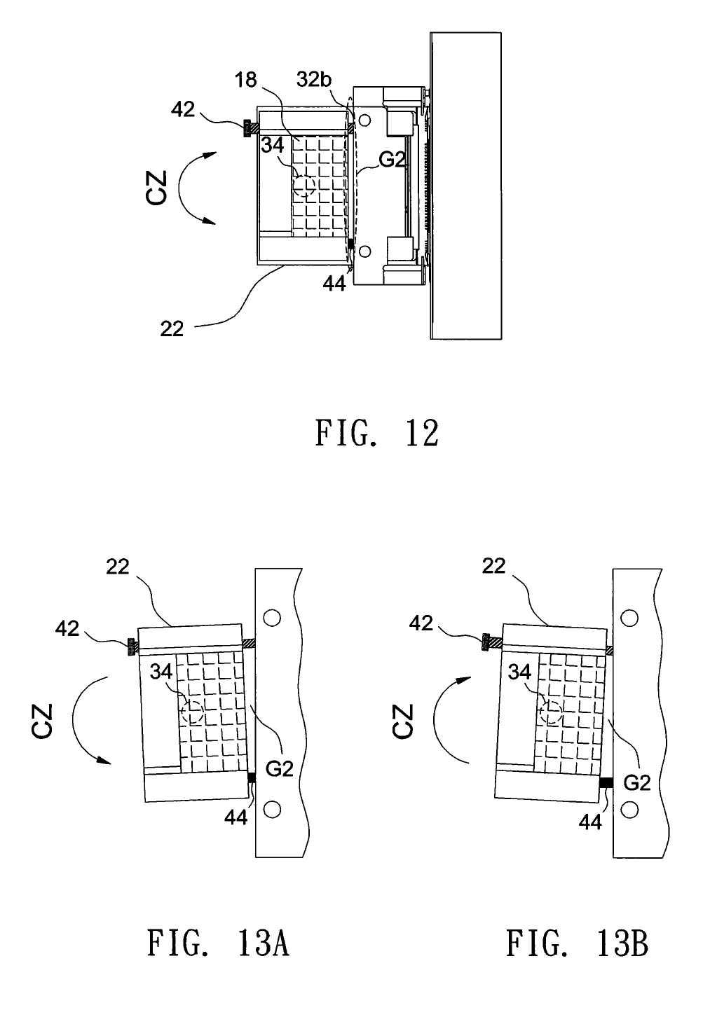

Hence, when the adjustment screw 42 is inserted into one side of the optics mount 22 (shown in FIG. 13A), an opposite side of the optics mount 22 is allowed to press the compression spring 44, and the optics mount 22 together with the reflective element 18 are forced to counterclockwise rotate along the rotation direction CZ to maintain force balance. In comparison, when the adjustment screw 42 is pulled out from the optics mount 22 (shown in FIG. 13B), the resilient force of the compression spring 44 that is opposite the adjustment screw 42 applies to the optics mount 22 to enable the optics mount 22 together with the reflective element 18 to clockwise rotate along the rotation direction CZ to maintain force balance. Hence in this embodiment, the reflective element 18 is allowed to clockwise or counterclockwise rotate about the Z-axis along the rotation direction CZ, therefore achieving the position adjustment relative to another dimension in space for the reflective element 18.

Through the above embodiments, a simple configuration is obtained to adjust the position of the reflective element 18 relative to the light-emitting device 14 in space. Hence, an expensive high-precision jig is no longer needed to considerably reduce the fabrication cost. Besides, the position adjustment mechanism 30 is suitable to use in the fabrication that incorporates the process of accelerating adhesive solidification, so the time for assembling a laser assembly is reduced, which is highly beneficial for mass production.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A position adjustment mechanism for laser optics used in a laser device having a heat-dissipating mount, at least one light-emitting device, an optics mount, and a reflective element, wherein the light-emitting device and the optics mount are provided on a first surface of the heat-dissipating mount and the reflective element is fixed on the optics mount, the position adjustment mechanism being used for adjusting the angle of incidence of the emitting light of the light-emitting device incident on the reflective element and comprising:
a fixed mount connected to the first surface of the heat-dissipating mount and positioned near the optics mount;
a fastening member penetrating the fixed mount and the optics mount to connect the fixed mount with the optics mount and maintaining a gap between the fixed mount and the optics mount; and
a position regulation device positioned in the vicinity of the fastening member and in the gap between the fixed mount and the optics mount, wherein the position regulation device presses against the optics mount to adjust the position of the reflective element relative to the light-emitting device.

2. The position adjustment mechanism as claimed in claim 1, wherein the fastening member comprises a first screw.

3. The position adjustment mechanism as claimed in claim 1, wherein the position regulation device comprises a wedge and the wedge is inserted into the gap between the fixed mount and the optics mount.

4. The position adjustment mechanism as claimed in claim 3, wherein a contact surface of the wedge pressing against the optics mount comprises an inclined plane.

5. The position adjustment mechanism as claimed in claim 1, wherein the position regulation device comprises a second screw and a third screw that are respectively provided on two sides of the fastening member and inserted into the gap between the fixed mount and the optics mount.

6. The position adjustment mechanism as claimed in claim 1, wherein the position regulation device comprises a second screw, a third screw and a fourth screw that are arranged in the shape of a triangle, positioned in the vicinity of the fastening member, and inserted into the gap between the fixed mount and the optics mount.

7. The position adjustment mechanism as claimed in claim 1, wherein the fastening member comprises a first screw and the position regulation device comprises a second screw and a compression spring, the first screw and the compression spring are respectively provided on two sides of the fastening member, the insertion direction of the first screw into the optics mount is perpendicular to the insertion direction of the second screw into the optics mount, and the compression spring is connected between the optics mount and the fixed mount.

8. A position adjustment mechanism for laser optics used in a laser device having a heat-dissipating mount, at least one light-emitting device, an optics mount, and a reflective element, wherein the light-emitting device and the optics mount are provided on a first surface of the heat-dissipating mount and the reflective element is fixed on the optics mount, the position adjustment mechanism being used for adjusting the angle of incidence of the emitting light of the light-emitting device incident on the reflective element and comprising:
a fixed mount connected to the first surface of the heat-dissipating mount and positioned near the optics mount;
a fastening member penetrating the fixed mount and the optics mount to connect the fixed mount with the optics mount, wherein a first reference axis, a second reference axis and a third reference axis perpendicular to one another are defined relative to the fastening member; and
a position regulation device positioned in the vicinity of the fastening member and in at least one gap between the fixed mount and the optics mount, wherein the position regulation device presses against the optics mount to enable the optics mount to swing about at least one of the first reference axis, the second reference axis and the third reference axis, so that the position of the reflective element relative to the light-emitting device is adjusted.

9. The position adjustment mechanism as claimed in claim 8, wherein the first reference axis, the second reference axis and the third reference axis are respectively the normal directions of a first plane, a second plane and a third plane that are adjacent to and perpendicular to one another, with the first plane being a light-receiving surface of the reflective element and the third plane being a contact surface of the reflective element in contact with the optics mount.

10. The position adjustment mechanism as claimed in claim 9, wherein the fastening member comprises a first screw and the first screw is inserted into the optical mount along a direction parallel to the third reference axis.

11. The position adjustment mechanism as claimed in claim 9, wherein the fixed mount comprises a base portion and a side portion that protrudes from the periphery of the base portion, a first gap is formed between the base portion and the optics mount, and a second gap is formed between the side portion and the optics mount.

12. The position adjustment mechanism as claimed in claim 11, wherein the position regulation device comprises a wedge and a contact surface of the wedge pressing against the optics mount comprises an inclined plane.

13. The position adjustment mechanism as claimed in claim 12, wherein the wedge is inserted into the first gap to enable the optics mount to rotate about the first reference axis or about the second reference axis.

14. The position adjustment mechanism as claimed in claim 12, wherein the wedge is inserted into the second gap to enable the optics mount to rotate about the third axis.

15. The position adjustment mechanism as claimed in claim 11, wherein the position regulation device comprises a second screw and a third screw that are respectively provided on two sides of the fastening member and inserted into the first gap along a direction parallel to the third reference axis.

16. The position adjustment mechanism as claimed in claim 11, wherein the position regulation device comprises a second screw, a third screw and a fourth screw that are arranged in the shape of a triangle, positioned in the vicinity of the fastening member, and inserted into the first gap along a direction parallel to the third reference axis.

17. The position adjustment mechanism as claimed in claim 11, wherein the fastening member comprises a first screw and the position regulation device comprises a second screw and a compression spring, the first screw is inserted into the first gap along a direction parallel to the third reference axis, the second screw is inserted into the second gap along a direction parallel to the first reference axis, and the compression spring is positioned in the second gap.

18. A laser assembly having a position adjustment mechanism, comprising:
a heat-dissipating mount;
at least one light-emitting device provided on a first surface of the heat-dissipating mount and adapted for emitting non-coherent light;
an optics mount provided on the first surface of the heat-dissipating mount;
a reflective element installed on a side of the optics mount and provided in the propagation path of the non-coherent light, wherein the reflective element reflects at least part of the non-coherent light and the light-emitting device and the reflective element are spaced apart to form a light resonance cavity;
a frequency-doubling chip installed on the side of the optics mount and provided in the propagation path of the non-coherent light; and
a position adjustment mechanism used for adjusting the angle of incidence of the non-coherent light of the light-emitting device incident on the reflective element, the position adjustment mechanism comprising:
a fixed mount connected to the first surface of the heat-dissipating mount and positioned near the optics mount;
a fastening member penetrating the fixed mount and the optics mount to connect the fixed mount with the optics mount, wherein a first reference axis, a second reference axis and a third reference axis perpendicular to one another are defined relative to the fastening member; and
a position regulation device positioned in the vicinity of the fastening member and in at least one gap between the fixed mount and the optics mount, wherein the position regulation device presses against the optics mount to enable the optics mount to swing about at least one of the first reference axis, the second reference axis, and the third reference axis, so that the position of the reflective element relative to the light-emitting device is adjusted.

19. The laser assembly as claimed in claim 18, wherein the first reference axis, the second reference axis and the third reference axis are respectively the normal directions of a first plane, a second plane and a third plane that are adjacent to and perpendicular to one another, with the first plane being a light-receiving surface of the reflective element and the third surface being a contact surface of the reflective element in contact with the optics mount.

20. The laser assembly as claimed in claim 18, wherein the fastening member comprises a first screw and the position regulation device comprises a wedge.

21. The laser assembly as claimed in claim 18, wherein the fastening member comprises a first screw and the position regulation device comprises a second screw, a third screw and a fourth screw.

22. The laser assembly as claimed in claim 18, wherein the fastening member comprises a first screw and the position regulation device comprises a second screw and a compression spring.
